(19) United States
(12) Patent Application Publication
(10) Pub. No.: US 2015/0154522 A1
(43) Pub. Date: Jun. 4, 2015

(54) METHOD OF ESTIMATING RISKS CAUSED BY ACCIDENTAL DROPPED OBJECT LOADS TO SUBSEA PIPELINES OR OTHER SUBSEA ASSETS ASSOCIATED WITH OFFSHORE OIL & GAS AND MARINE OPERATIONS

(71) Applicant: Global Maritime AS, Stavanger (NO)

(72) Inventors: Cristian MIRCEAN, Stavanger (NO); Srinivasan KARUNANITHI, Stavanger (NO); Helge HYDLE, Hafrsfjord (NO)

(21) Appl. No.: 14/474,825

(22) Filed: Sep. 2, 2014

(30) Foreign Application Priority Data
Dec. 4, 2013 (NO) 20131608

(51) Int. Cl. G06Q 10/06; G06Q 50/08; B66C 13/00

(52) U.S. Cl. CPC G06Q 10/0635; B66C 13/00; G06Q 50/08

(57) ABSTRACT

A method of estimating risk of at least one accidentally dropped object load from at least one crane on a platform or vessel includes providing or generating a schematic representation of a sea level area; identifying a drop area for accidental drops of the at least one accidentally dropped object load from the crane based on image processing of the schematic representation of the sea level area; estimating probability density of risk of accidentally dropped object loads based on a multitude of drop points within the drop area; and representing the sea level area, the subsea area, and estimating probability of risk of accidentally dropped object loads using data representations in the form of at least one of matrix-type data, raster graphic image, or dot matrix data for location, estimated risk values and other statistics.

The present invention concerns a method of estimating risk of at least one accidentally dropped object load from at least one crane on a platform or vessel, as well as a risk management tool, a decision support method, a risk management planning and a business consultancy method.

### BACKGROUND

Managing the risk introduced by lifting activities above subsea pipelines and other subsea assets is critical for safe offshore oil & gas and marine operations. Accidental dropped objects into the sea may affect the operations and there is an inherent risk of hitting the subsea assets, particularly with serious consequence when pipes are under pressure and transport flammable hydrocarbons or other hazardous fluids.

Quantitative dropped object risk assessments are relevant for any marine operations requiring a large number of lifts between platforms/rigs and supply vessels above subsea assets.

In these operations, “sea-level components” are platforms (drilling or production), and supply vessels. Typical lifted objects are containers, baskets, conductor casings, completion tubings, drilling pipes, XT Christmas Tree, XT Christmas Tree counter weight; lowering the BOP on the safe zone. The “subsea items” in these operations are flow-lines for stabilized crude oil export, umbilicals, gas injection lines, production templates.

The Recommended Practice DNV-RP-F107, “Risk Assessment of Pipeline Protection—DNV Recommended Practices; Det Norske Veritas, which is hereby incorporated by reference; presents a risk-based approach for assessing pipeline protection against accidental external loads. Recommendations are given for the damage capacity of pipelines and alternative protection measures and for assessment of damage frequency and consequence. This recommended practice focuses on providing a methodology for assessing the risks and required protection from dropped crane loads and ship impact to risers and pipeline systems within the safety zone of installations. Accidental scenarios with other relevant activities such as anchor handling, subsea operations and trawling are also discussed.

Although the DNV-RP-F107 is the main source for recommended practice for risk of dropped objects into subsea, its model does not take into account multiple drops in various locations of the “drop area”. Hit probabilities and consequent risk estimates arise from a small number of drops (typically one) called “worst case scenario”, sometimes based on conjecture.

The one dimensional (1 D) model as described in DNV-RP-F107 has limitation with reference to the estimation of probabilities at the point of hitting the sea surface, and cannot be applied in two dimensional (2D) space where the accidental dropping of objects will hit subsea assets.

The existing methods draw from the drop point concentric rings of increasing 10 meters radius. Evaluating the hit probability is based on the excursion of the objects and the length of pipeline within each ring and the pipeline diameter and object size. The existing methods require the knowledge of the subsea and lifts for estimations.

### SUMMARY OF THE INVENTION

The present invention provides a new risk analysis tool and methodology supporting the characterization of risks caused by accidental dropped object loads to the subsea pipelines or to other assets.

In an aspect the invention provides a method of estimating risk of at least one accidentally dropped object load from at least one crane on a platform or vessel, comprising:
providing or generating a schematic representation of a sea level area comprising at least a layout of the platform or vessel and a layout of a maximum and minimum crane handling radius of the at least one crane;
identifying a drop area for accidental drops of the at least one accidentally dropped object load from the crane based on image processing of the schematic representation of the sea level area;
estimating probability density of risk of accidentally dropped object loads based on a multitude of drop points within the drop area for the at least one accidentally dropped object load or at least one object category; and
representing the sea level area, the subsea area, and estimating probability of risk of accidentally dropped object loads using data representations in the form of at least one of matrix-type data, raster graphic image, or dot matrix data for location, estimated risk values and other statistics.

The method may further comprising representing a probability density of risk of the at least one accidentally dropped object load as contour isolines, isarithms or isopleths on the schematic representation of the sea level area. A hit probability function may be estimated based on two-dimensional normal distribution for at least one accidentally dropped object load.

The method may further comprise providing a schematic representation of a layout of a subsea area comprising the subsea pipelines and other subsea assets, and extracting from said schematic representation of the layout of the subsea area at least segments and sub-segments of the subsea pipelines and the subsea assets generating a mask of said subsea pipelines and the subsea assets. The area where an accidental drop may affect respective segments and sub-segments of pipelines and other subsea assets may be extracted. A risk of dropped objects or a hit probability for each segment of subsea asset, pipeline, and other subsea assets may further be estimated. Interpolation may be used to improve accuracy for at least one estimate of risk of dropped objects or a hit probability.

The method may further comprise representing the segments and sub-segments of pipelines and other subsea assets, or area where an accidental drop hit may affect respective segments and sub-segments of pipelines as contours together with contour isolines, isarithms or isopleths of probability density of risk of the at least one accidentally dropped object load.

A probability density of risks of the at least one accidentally dropped object load may be estimated for at least a part of a safe zone of the subsea area based on the multitude of dropped objects. A participation of a lift or combination of lifts by the at least one crane may be represented as a risk probability density for at least a part of a safe-zone of the subsea area by contour isolines, isarithms, or isopleths providing quantitative iso-values of risk caused by the at least one accidental dropped object load to the subsea pipeline or subsea assets. A participation of a lift category or combination of lift categories of lifts of an object load by the at least one crane may be represented by contour isolines, isarithms, or isopleths providing quantitative iso-values of risk caused by the at least one accidental dropped object load to the subsea pipeline or subsea assets.

The method may further comprise defining limitations of the supply vessel position or optimizations of such position to reduce the risk of accidental dropped objects on subsea assets. Optimizing or defining limitations of a crane handling area may be performed based on living area or restricted zones on the platform. Optimizing or defining limitations may be performed based on a crane mobility limitations as an angle.

A hit probability of each sub-section of the subsea pipeline or subsea asset may be calculated from matrix-type data, raster graphic image, or dot matrix data structure. A hit probability of the subsea pipeline or subsea asset may be calculated from matrix-type data, raster graphic image, or dot matrix data structure. At least one of a hit frequency vs. impact energy may be calculated from values extracted from matrix-type data, raster graphic image, or dot matrix data structure. At least one of a damage classification or accumulated frequency vs. impact energy may be calculated from values extracted from matrix-type data, raster graphic image, or dot matrix data structure.

The method may further comprise calculating a safe distance from the subsea pipelines and subsea assets for lowering a BOP (Blowout Preventer) or estimating risk of dropped objects while performing heavy lifts of at least an object load by the at least one crane.

The invention also provides a risk management tool for estimating accidental dropped object loads on subsea pipelines and other subsea assets, using a method according to at least one of claims 1-19.

The invention also provides a decision support method for estimating accidental dropped object loads on subsea pipelines and other subsea assets, using a method according to at least one of claims 1-19.

The invention also provides a method and a system for risk management planning, for optimizing of lifts of object loads; or other marine operations using a method according to at least one of claims 1-19.

The invention also provides a business consultancy method, or business management system, providing mitigation measures or risk reduction consultancy using a method according to at least one of claims 1-19.

The present invention relates to a method, risk management procedure, process, an instrument, and apparatus for protection of subsea assets, which method comprises at least estimating and representing density probability of object drop risk caused by accidental dropped object loads to the subsea assets as matrix-type data, raster graphic image, or dot matrix data structure.

The present invention further relates to a system for protection of subsea assets, which system comprises at least estimating or representing density probability of dropped object risk as matrix-type data, raster graphic image, or dot matrix data structure.

The present invention further relates to business consultancy method, risk management method, or business management system, which system comprises at least estimating or representing density probability of dropped object risk as matrix-type data, raster graphic image, or dot matrix data structure.

The method, the representations, the risk management procedure and process described in this invention can be used for production platforms, exploration, drilling and completion, loading/unloading from barges, and remotely operated underwater vehicles (ROVs; Remotely Operated Vehicle) vessels or multipurpose vessels.

For each lift, based on historical data, load (i.e., lift weight), and crane type—there is a historical frequency of lifts to drop into the sea (not assessed in this invention).

The dropped objects may affect operations and damage subsea assets depending on direction of dropped objects travelled from sea level to the subsea floor. Based on company own standard, industry recognized standards or other regulations, for each subsea asset the risk from dropped objects should be evaluated before installation and operation.

Representing the density probability of risk and providing estimates according to the invention allow operators and other decision makers to better understand and visualize dropped objects risk with reference to the risk acceptance criteria. This will support the respective stakeholders to find the most effective risk reducing measures. Furthermore, methods and the effort is enhanced by designing a tool that allows a unitary flow of calculations for assessing risks of dropped objects into sea.

The method and the representation in this invention allow decision makers to understand dropped objects risk with reference to risk acceptance criteria and find the most efficient risk reducing measures.

Contrasting the prior art, the embodied method pre-calculates density probability of hit for entire safe-zone area in question for a presumptive drop in each (shape) category, where categories describe a lateral deviation, but as well, identify risks and suitable controls to reflect increasing risk and increasing level of control required for respective lifts. It allows computational load before customizing lifts or layout/design of subsea assets. The pre-calculations (which can be completed for areas with or without subsea assets) provide means for easier sensitivity analysis of lifts or customization of protection.

The embodied method propose to estimate and represent the probability density function of risk of accidental events which lead to external interference with risers, pipelines, umbilicals, etc. Invention employs contour isoline, isarithm, or isopleth to represent object hit frequency and object drop probability that quantify risk caused by accidental dropped object loads to the subsea pipelines and to other assets.

### BRIEF DESCRIPTION OF DRAWINGS

Example embodiments of the invention, aspects and advantages will be better understood from the following detailed description which will now be described with reference to the followings drawings, where:

FIG. 1 schematically presents a main crane of a platform performing lifting activities, where the lifts are raised from the supply vessel and placed on the platform deck. There is a potential risk that the lifted object drops into the sea, and a potential risk that subsea assets are affected;

FIG. 2 is a block diagram representing the method according to an embodiment of the invention;

FIG. 3 illustrates random drops in a final mask of a “drop area” of a port crane together with risk contour isoline;

FIG. 4 is a representation of a probability density of risk of accidental dropped object loads to the subsea assets for a set of lifts by employing contour isoline, where a number of isoline curves are labeled with their iso-value;

FIG. 5 illustrates position of random drops in the “drop area” that includes limitations—in this case limitations are based on supply vessel and rig architecture limitations;

FIG. 6 represents a segmented subsection and the respective area where a hit may affect the respective subsection of the subsea asset, where the radius is based on the width of the lifted object and the asset diameter;

FIG. 7 illustrates the interpolated estimate (upper) and the residuals of interpolation (lower) for five (or less) points required for increased resolution of hit probability based on the available contour-steps around the respective desired contour value;

FIG. 8 graphically represents the accumulated leak or damage frequency per subsea element calculated with embodied method from matrix-type data;

FIG. 9 shows an optimization analysis of introducing supply vessel (right) compared to the baseline (left), accumulated frequency vs. impact energy is calculated from matrix-type data;

FIG. 10 shows an optimization analysis of modifying the position of supply vessel parallel with the platform (left, baseline) as compared to the orthogonal position (right), accumulated frequency vs. impact energy is calculated from matrix-type data;

FIG. 11 shows optimization analysis of lifts, with a decrease of the accumulated leak frequency per subsea element when part of the lifts are lifted with port crane compared to the initial planned starboard crane; a 2D contour isoline representation of the difference in hit frequency; and

FIG. 12 shows the safe zone for lowering BOP, values calculated from matrix-type data.

### DETAILED DESCRIPTION

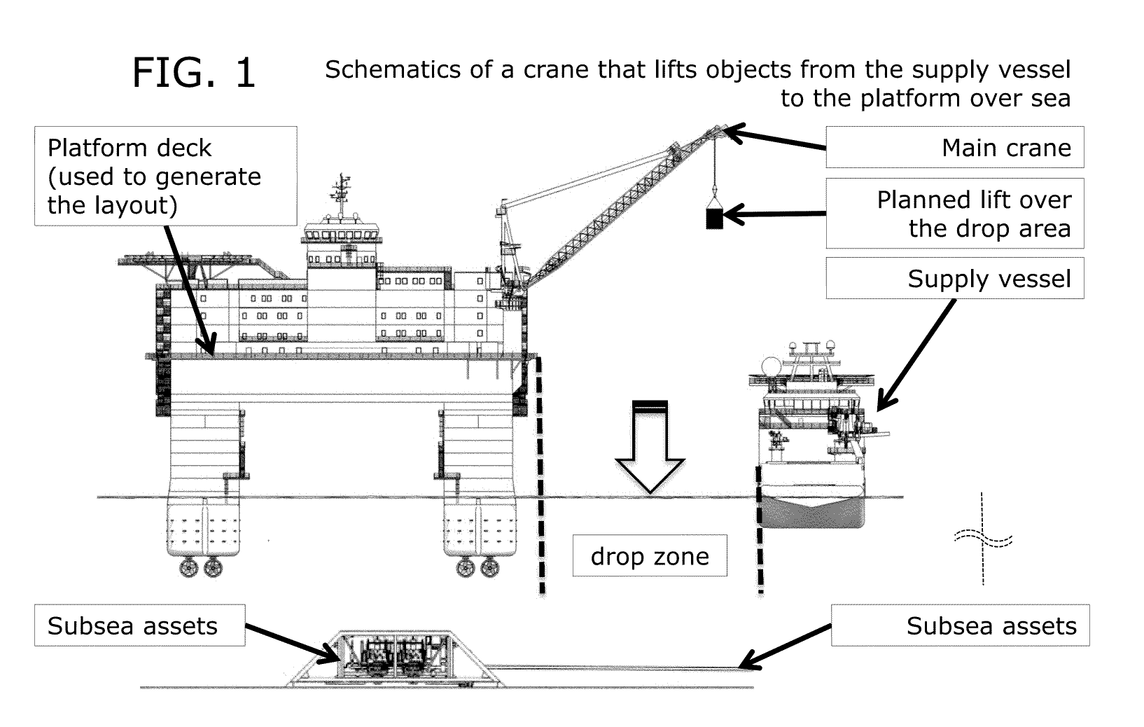

FIG. 1 shows a schematic of a platform for offshore oil and gas operations. A supply vessel is positioned adjacent the platform. The platform is provided with a main crane that lifts objects from the supply vessel to the platform over sea. The main crane performs a planned lift over a drop area. The loads are raised from the supply vessel and placed on the platform deck. There is a potential risk that the lifted object drops into the sea, and a potential risk that subsea assets are affected. The drop zone marked with an arrow in FIG. 1 is the zone where the load will come down if the load is accidentally dropped by the main crane. The platform deck is used to generate a layout of the platform. The dotted lines in FIG. 1 represent projections of a layout of the vessel and the platform onto a horizontal plane providing a part of a sea level area.

The invention provides a method of estimating risk of at least one accidentally dropped object load from at least one crane on a platform or vessel. The method comprises providing or generating a schematic representation of a sea level area comprising at least a layout of the platform or vessel and a layout of a maximum and minimum crane handling radius of the at least one crane. A drop area for accidental drops of the at least one accidentally dropped object load from the crane is identifying based on image processing of the schematic representation of the sea level area. Probability density of risk of accidentally dropped object loads is estimated based on a multitude of drop points within the drop area for the at least one accidentally dropped object load or at least one object category. The sea level area and the subsea area are represented by using data representations in the form of at least one of matrix-type data, raster graphic image, or dot matrix data. The estimates of probability of risk of accidentally dropped object loads are represented using data representations in the form of at least one of matrix-type data, raster graphic image, or dot matrix data for location, estimated risk values and other statistics.

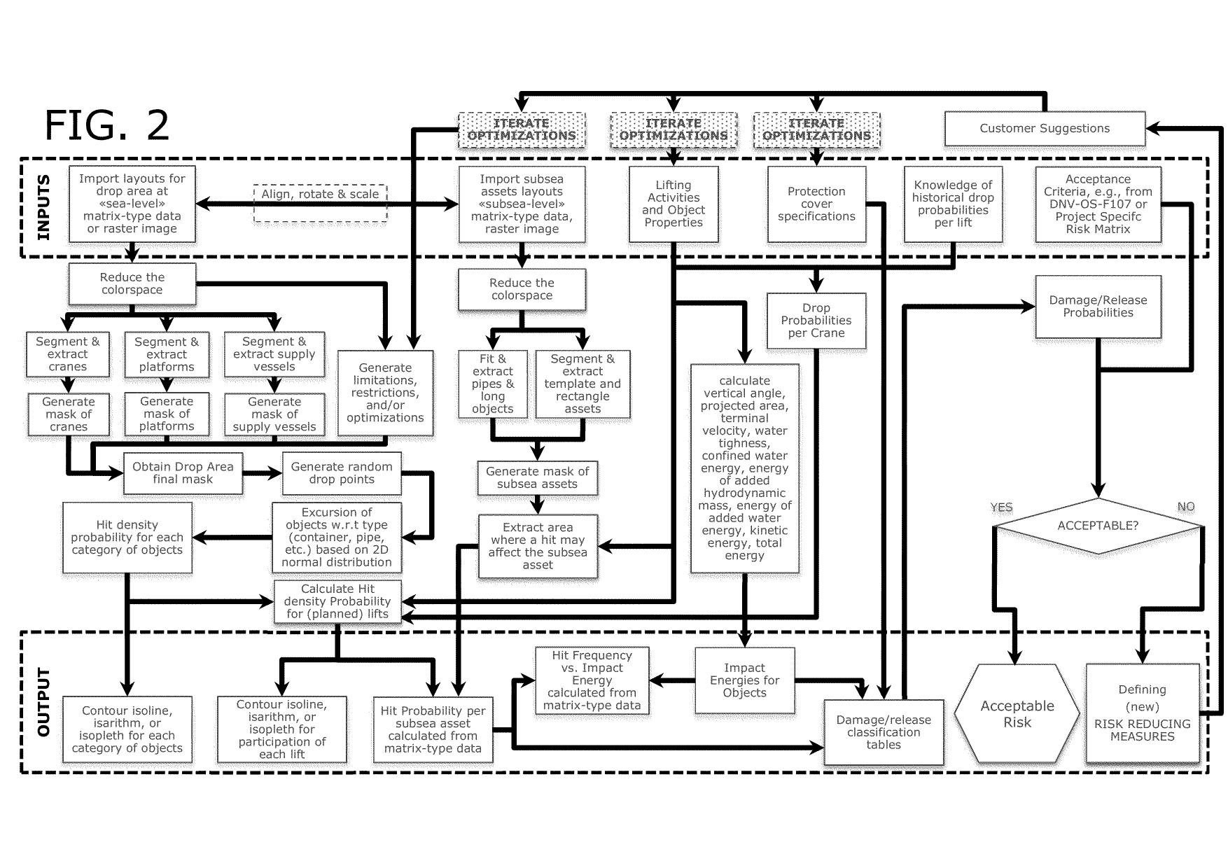

FIG. 2 shows a chart representing an embodiment of the method of estimating risk of at least one accidentally dropped object load from at least one crane on a platform or vessel. A number of inputs are provided, a number of calculations and estimations are performed by a computer system and a number of outputs are provided. Optimizations may be provided to at least some of the inputs, calculations and estimations based on customer suggestions.

The inputs are at least one of:
Importing layouts for drop area at “sea level” as matrix type data or raster image or as a dot matrix data structure.
Importing subsea assets layouts of “subsea level” as matrix type data or raster image or as a dot matrix data structure.
Lifting activities and object properties.
Protection cover specifications.
Knowledge of historical drop probabilities per lift.
Acceptance criteria e.g. from Recommended Practice DNV-RP-F107, October 2010, or project specific risk matrix.

The outputs are at least one of:
Contour isoline, isarithm or isopleths for each category of objects to the lifted.
Contour isoline, isarithm or isopleths for participation of each lift.
Hit probability per subsea asset calculated from matrix-type data.
Hit frequency vs. impact energy calculated from matrix-type data.
Impact energies for objects.
Damage/release classification tables.
Acceptable risk
Defining (new) risk reducing measures.

Calculations and estimations are performed on at least one of the inputs in order to create at least one of the outputs. The calculations and estimations may be performed by a number of modules in a computer system.

The imported layout(s) for “sea level” are reduced in color space. The resulting layout for “sea level” is segmented and information extracted regarding cranes, platforms and supply vessels. At least one mask of the cranes, platforms and supply vessels is generated. The resulting layout is also used as a basis for generating limitations, restrictions, and/or optimizations. The limitations, restrictions, and/or optimizations may also be influenced from iterated optimizations from customer suggestions.

A final mask of the drop area is obtained based on the at least one mask and any limitations, restrictions, and/or optimizations. The random drop points are generated from this final mask of the drop area. Excursion of objects with respect to type (e.g. container, pipe, etc.) is performed based on a 2D normal distribution. This results in calculations of a hit density probability for each category of objects. This hit density probability is output. The output may be in the form of a contour isoline, isarithm or isopleth for each category of objects.

Also, a hit density probability for planned lifts may be calculated and output. The output may be in the form of a contour isoline, isarithm or isopleth for participation of each lift. The hit density probability may also take into account lifting activities and object properties, drop probabilities per crane and knowledge of historical drop probabilities per lift.

The input import of subsea assets layouts “subsea level” as matrix-type data or raster image, are further reduced in color space. From this reduced layout pipes and long objects are fitted and extracted. From this reduced layout a template and/or other rectangle assets are segmented and extracted. A mask of the subsea assets are generated from the extracted pipes and long objects and the extracted rectangle assets. An area where a hit may affect the subsea asset is extracted based on the mask of subsea assets, the lifting activities and object properties and knowledge of historical drop probabilities per lift. A hit probability per subsea asset is calculated from matrix type data from the calculated hit density probability for planned lifts and the extracted area where the hit may affect the subsea assets.

The lifting activities and object properties together with knowledge of historical drop probabilities per lift are also used in calculating vertical angle, projected area, terminal velocity, water tightness, confined water energy, energy of added hydrodynamic mass, energy of added water energy, kinetic energy, and total energy. From this, the impact energies for objects are calculated and output. Input protection cover specifications are used in creation of output damage/release classification tables. The output damage/release classification tables are also created based on hit probability per subsea asset calculated from matrix-type data. The output damage/release classification tables are used for estimation of damage/release probabilities. It is assessed whether the probability is acceptable or not. If the probability is not acceptable (no), a risk reducing measure is output. This risk reducing measure may be new.

The lifting activities and object properties, the protection cover specifications and the generated limitations, restrictions and/or optimizations may be iterated optimizations based on customer suggestions.

The method is explained in more detail below.

The method includes at least one of the following features:
1) Importing the layouts for the drop area at above “sea-level” as matrix-type data, raster graphic image, or dot matrix data structure. These include the layout of the platform and cranes.
   Importing the layouts for the drop area at “subsea level” as matrix-type data, raster graphic image, or dot matrix data structure. These include schematics of subsea pipelines and the subsea assets.
   Image shall be acquired at known high resolution and tools are provided to process various image formats and unify the formats for the next steps. The layouts of the “sea-level” and “subsea level” may be aligned, rotated and scaled.

2) Reduce the color space of above raster graphic image to relevant information carried within image and robustly quantize it. Work space is further stored and used as a matrix. Elements of the matrix are representing a specific space with known resolution (e.g., 1 element is 1 m², 1 element is 0.0625 m², etc.). The scale and the orientation of the subsea layout and platform, crane shall be same. The “sea-level” and “subsea assets” shall superimpose or enough parameters shall be known to superimpose the layers.
3) In drawings, cranes are typically represented by circles; or ellipse in case the scale on vertical and horizontal axis are not the same. Information on cranes can also be obtained numerically from stakeholders. There is a maximum crane radius of which is dependent on the load and the design of crane. The minimum radius is dependent on the boom of the crane or other restrictions. There are two processes of extracting the crane information graphically. Primarily, fitting the ellipsoid to the known representation of the crane (e.g., by choosing color and distance weighted function). Second, if the previous is not successful, to use segmentation techniques that may provide the background (and reduce complexity) before fitting respective circle. The third method accounts on visually superimposing an ellipse. In each case, based on scale, the method automatically calculates the origin of the crane and the two radius values. These values can be adjusted numerically and confronted with the numerical values obtained from stakeholders. This last step allows verification of scale. The resulted layout of the cranes is typically a binary mask of ones (i.e., true logical value) of the same size as the image.

4) The layout of the platform(s) can be obtained from segmentation e.g. using a classical Chan-Vese method. As well, information on layout of the platform(s) can be obtained numerically from customers. It is possible to describe the platform layout by using multi-polynomial spaces or other methods that describe masks of logical values. The resulted layout of the platform is typically a mask of zeros (false logical value).
5) A number of operational aspects that will have an impact on the results called here “optimizations” or introducing “limitations” may be tested according to the model:
   a. Optimizations based on the supply vessel position can be graphically addressed with a segmentation technique (e.g., using a classical Chan-Vese segmentation) if the images contain representation of the supply vessel. Also, similar to the platform(s) layout one may introduce the restrictions of the supply vessel by using multi-polynomial spaces or other methods that describe masks of logical values. In later case, the coordinates of position are shown. The resulted layout of the restrictions is typically a mask of zeros (false logical value).
   b. Optimizations based on restricted zones can be similarly addressed by using multi-polynomial spaces or other methods that describe masks of logical values. In the latter case, the coordinates of position are shown. The resulted layout of the restrictions is typically a mask of zeros (false logical value).
   c. The limitations based on crane limitations can be introduced either by methods similar to the platform(s) layout by using multi-polynomial spaces or other methods that describe masks of logical values. Also, a pair-angle (called up-angle and down-angle) with values in the range [0°-360° ] degrees can be introduced. Special attention shall be enforced on the relative direction of the provided angles from drawings and the angle in the graphical representation of the method. The resulted layout of the restrictions is typically a mask of zeros (false logical value) complementing the crane mask of ones (true logical value).
6) Individually for each of the cranes, derrick or other crane-type—through a final mask comprised of the crane mask of “ones” (true logical value) and mask of “zeros” (false logical value) of platform, a restriction is created. This mask can be represented in the tool.
7) In the final mask of ones (true logical value) called “drop area” defined above, we randomly define possible drops. The higher the density of drops, the higher the computational load. As well, the higher the relative resolution, the higher computational costs. Assuming the model is correct and valid, the confidence of estimates is increasing and saturates with the increase of resolution and density of drops. In our estimates, we used with success 0.625 [m⁻²] estimates, generating typically 3000-5000 drop calculations.
8) For each drop we use the two-dimensional normal distribution. Other distributions may effectively represent dropped objects.
9) A hit probability function is calculated for each category of lifted objects.

Categories are related to lateral deviation, but as well to identify risks and suitable controls to reflect increasing risk and increasing level of control required. The method calculates the maximum effect for each category, called here envelope of the result for the upper described random points. The envelope is slightly biased considering “worse scenario”: for each individual subsea subsection considers drops that worse will affect the respective subsections. One may use the average instead of the maximum effect.
10) The method extracts the layout of the subsea assets. The sub-segments of the subsea assets may have distinct impact capacity and distinct cover protection. For this reason, assessing individually each sub-segment is preferable. The method uses a structure to handle individual sub-segments details and binary masks.
   a. Assets may comprise of pipes, umbilicals and other structurally long-shaped elements. The scale of such assets is not typically passed in the drawings. To better estimate the position, the embodied method tests various fitting procedures that assess the robustness of fit in each case. A mask of ones (true logical value) is created for each sub-segment.
   b. Other subsea assets are extracted using segmentation (e.g., using a classical Chan-Vese segmentation). Also, it is possible to describe the “non-long shaped elements” layout by using multi-polynomial spaces or other methods that describe masks of logical values. The resulted layout of the platform is typically a mask of ones (true logical value).
11) Lifts are represented in a structure-type from a table-type input and processed to obtain the vertical angle, projected area, terminal velocity, water-tight characteristics, confined water energy, energy of added hydrodynamic mass, energy of added water energy, and energy of added hydrodynamic mass, kinetic energy, and total energy.
12) The method allows representing the participation of lift categories (or groups of lift categories) to the quantified risk caused by accidental dropped object loads to the subsea assets by employing contour isoline (also known as isarithm, or isopleth). The representation depicts density probability as quantitative risk overlaid with subsea elements.
13) Based on individual lifts and for each crane, the hit density probability function is calculated from respective category of each object.
14) The method allows representing the participation of each individual lift (or groups of lifts) to the quantified risk caused by accidental dropped object loads to the subsea pipelines and to other assets by employing contour isoline (also known as isarithm, or isopleth). The density probability is estimated and represented for entire rig safe-zone as quantitative risk per subsea area. element
15) The method segments (i.e., partitioning of image) each sub-segment of the subsea assets.
16) Based on location of each subsea asset with its sub-elements, based on the dimension of each lifted object and the diameter of the subsea element e.g., diameter of each pipe—the method calculates the hit probability per sub-section of subsea asset. This uses a customized five-point element estimation method to quantify risk caused by accidental dropped object loads for each sub-section of subsea pipeline. The effects of sub-sections are accumulated and summarized for each subsea element.
   a. Five-point estimate in here is the interpolated estimate of five (or less) points of hit probability based on the contour-steps available (due to resolution) around the respective desired contour value. Method uses robust first degree exponential for stability and low Kolmogorov complexity of fitting model, although other estimates may perform as well.

17) The method calculates the hit frequency vs. impact energy from values extracted in previous steps.
18) The method calculates the damage classification that takes in account the protection covers for individual sub-sections of the subsea assets.

19) The method calculates the accumulated frequency vs. impact energy.
20) The method calculates the object drop frequency. Depending on the project needs the appropriate industry recognized historical drop frequencies are used.

The method of estimating risk of at least one accidentally dropped object load from at least one crane on a platform or vessel, the representations, the risk management procedure and process described above can be used, but not limited to the following offshore oil & gas, and marine operations:
Production operations: The main assets involved with offshore oil & gas production operations are jack-up, semi-submersible, tension-leg platforms and floating production storage and offloading (FPSO) units. Typical objects being lifted for a production operation are containers, cargo baskets, transport racks, lifting frames, tanks, etc. If drilling activities are carried out on the same platform, the objects such as BOP, mud tanks, drill strings, casings, conductors, etc. may also be lifted from/to supply vessels.
Drilling and maintenance of well operations: Typical activities of drilling and maintenance of well operations are exploration, development, completion, wire lining, coiled tubing, snubbing and workover. Jack-up and semi-submersibles are the main types of rigs involved with drilling and maintenance of well operations all over the world. Typical objects being lifted are containers, cargo baskets, transport racks, BOP, mud tanks, drill strings, casings, conductors, etc.
Accommodation operations: Accommodation units or flotels are used for an additional accommodation for personnel in the offshore. These flotels are often connected with a main production platform or a drilling rig. Typical lifts are associated with accommodation purpose on board.
Heavy lifting marine operations: Crane vessels and heavy lift offshore cranes are mainly used for major offshore lifting operations.

Lifts associated with these operations may be dropped onto sea where there is a risk of hitting the subsea assets such as risers, hydrocarbon pipelines, umbilicals and production templates.

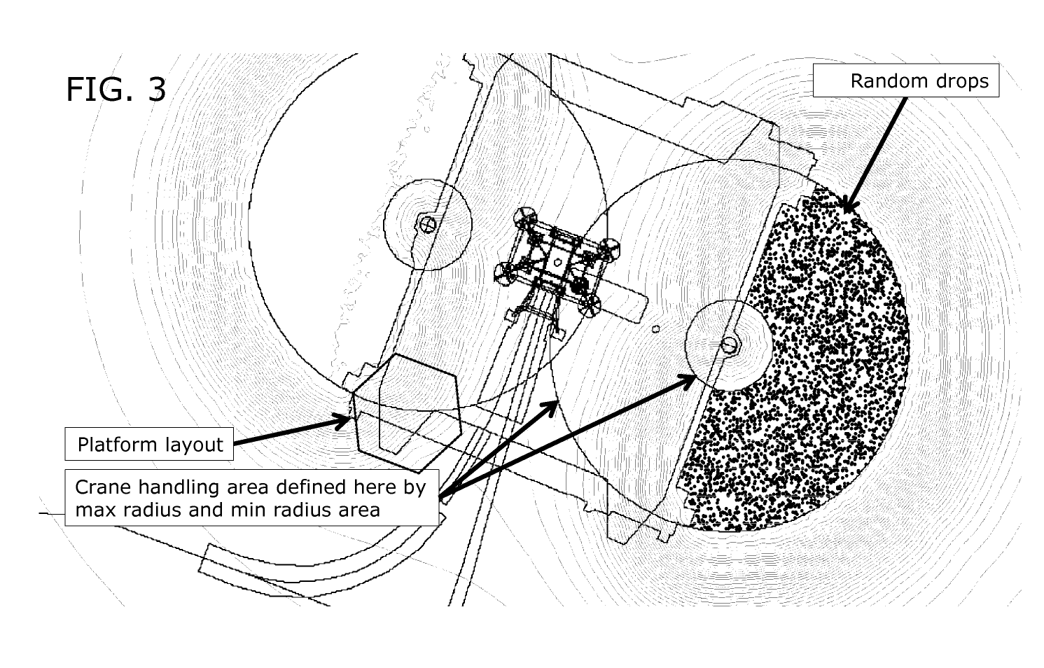

Example embodiments of the invention are illustrated in the FIGS. 3-12 and explained below based on the illustration of the platform with two cranes, the subsea assets and supply vessel of FIG. 1.

FIG. 3 illustrates random drops in a final mask of a “drop area” of a port crane together with risk contour isoline. A platform layout is shown together with a crane handling area defined by a maximum radius and a minimum radius area of the two cranes, on opposite sides of the platform. In FIG. 3 there is a crane on each side of the platform. Both cranes are used for lifts. A number of random drops are simulated, the simulated random drops are represented by a dot within respective drop area of port crane.

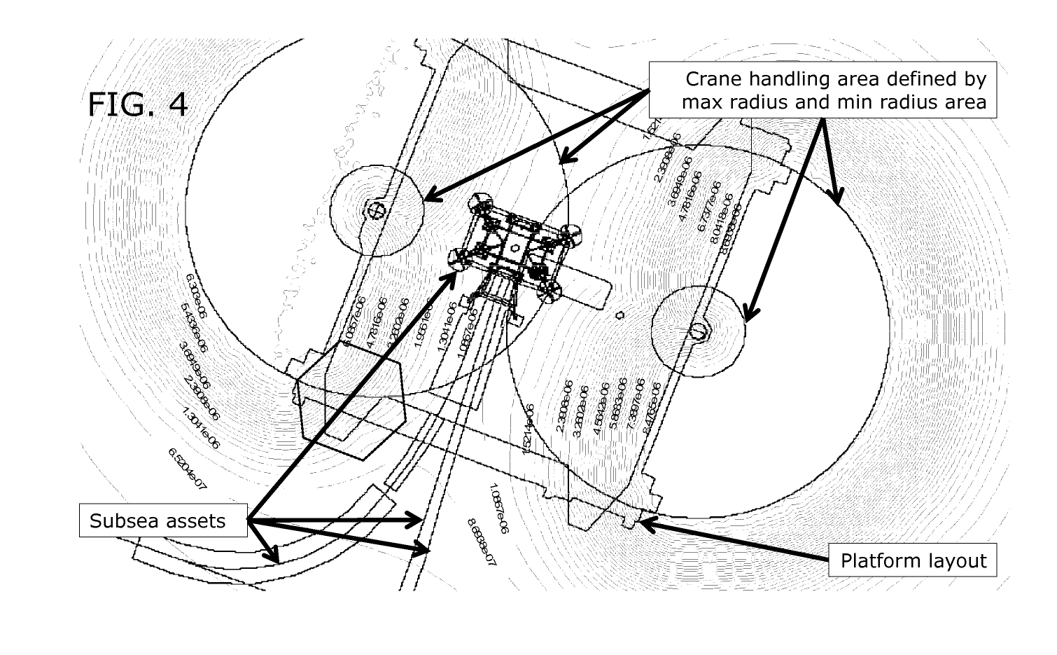

FIG. 4 is a representation of a probability density of risk of accidental dropped object loads to the subsea assets for a set of lifts. The probability density of risk is calculated and represented for lifts performed with the two cranes. The risk probability densities are represented graphically by employing contour isoline, where a number of isoline curves are labeled with their iso-value. The subsea assets, together with the crane handling areas defined by the maximum crane radius area and the minimum crane radius area, and the platform layout are visualized as lines. On the drop zones, the probability density of risk of dropped objects is high and has little variation, therefore there are no major contour lines inside respective area.

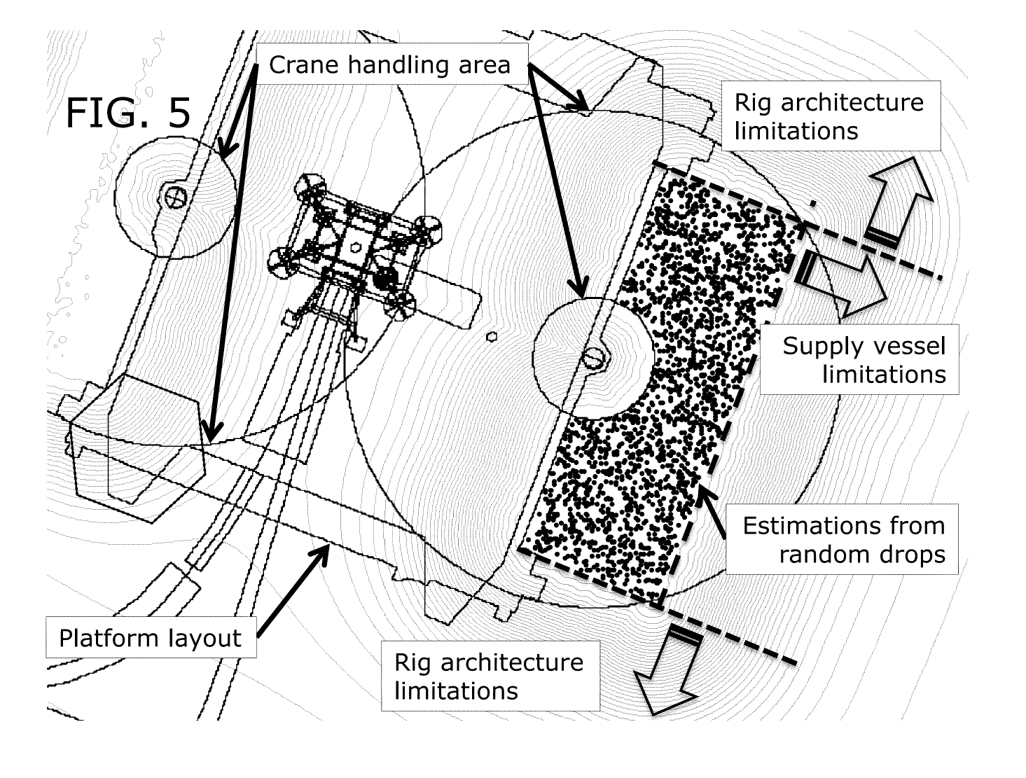

FIG. 5 is the representation from FIG. 4, where limitations based on supply vessel and rig architecture are introduced for the port crane (the right side of the figure). The limitations are for illustration purposes corresponding to the situation exemplified in FIG. 1. The “drop area” is limited to a rectangle form as the sea area to which the object load may be dropped is delimited by the supply vessel and the rig. A number of random drops are calculated in the rectangular “drop area” are shown as dots. Risk estimations are based on these random drops. The risk probability densities are represented graphically by employing contour isolines.

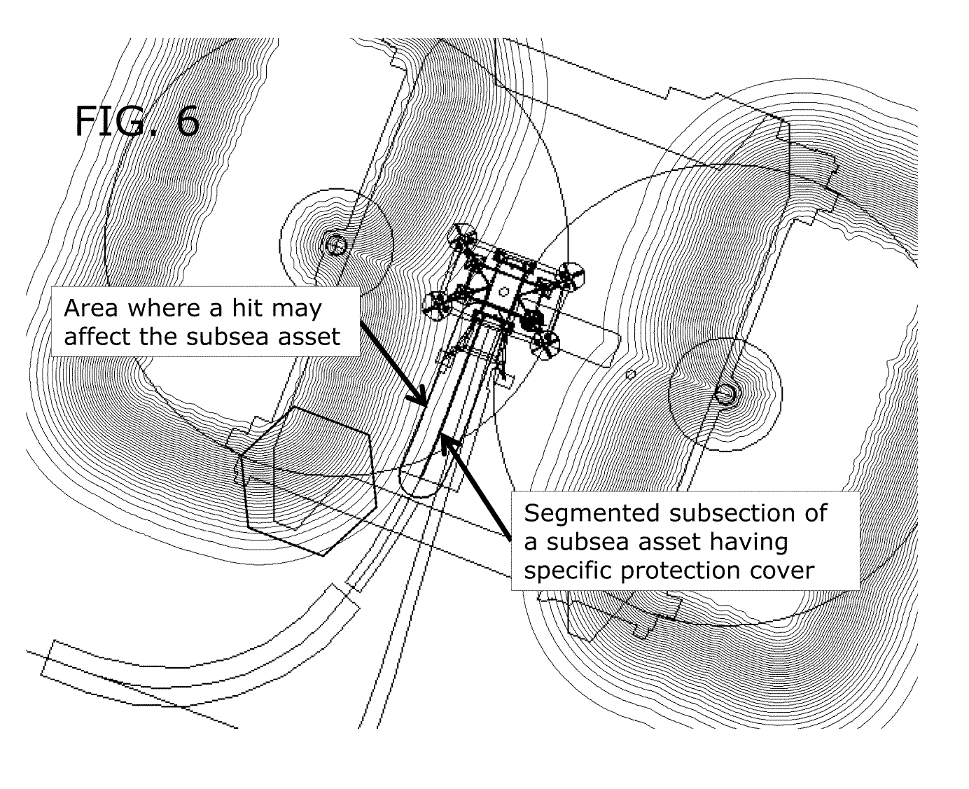

FIG. 6 shows the situation from FIG. 4, and visualizes a segmented subsection of a subsea asset having a protection cover. An area where a hit may affect the subsection of the subsea asset is marked with a bold line. The radius is based on the width of the lifted object and the subsea asset diameter.

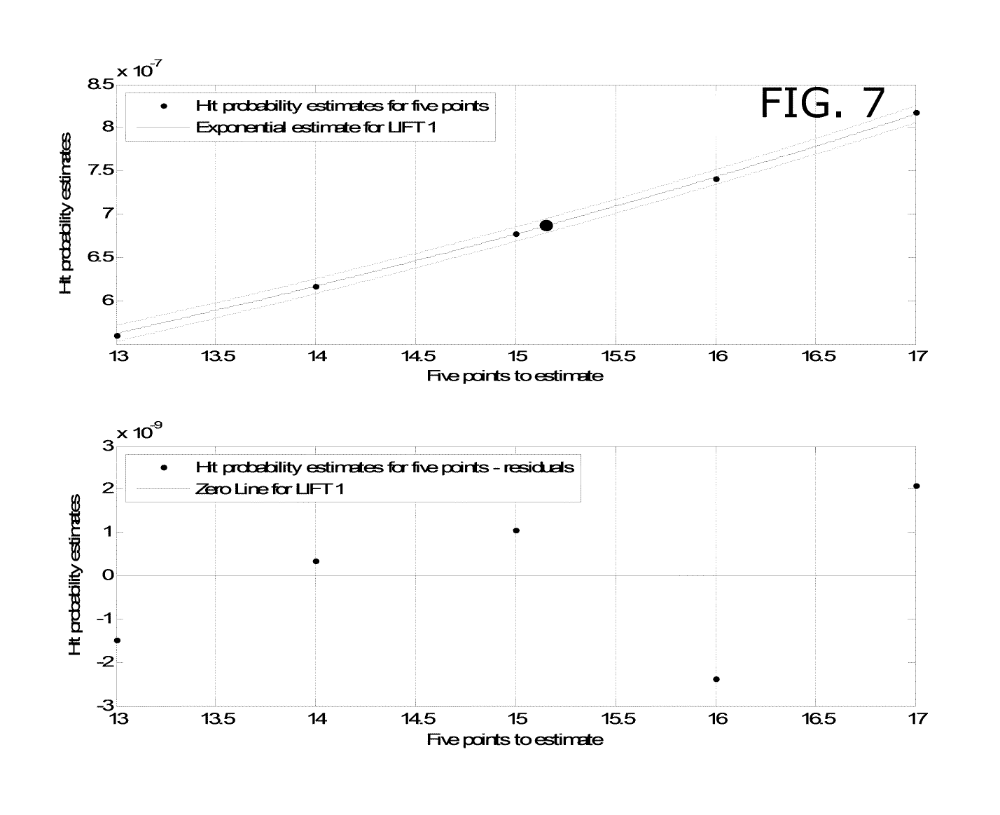

FIG. 7 illustrates in the upper graph the interpolated estimate for a hit probability, estimates based on interpolation of five points. The interpolation uses exponential function. FIG. 7 illustrates in the lower graph the residuals of interpolation for five (or less) points. Interpolation is required for increased resolution of hit probability based on the available contour-steps around the respective desired contour value.

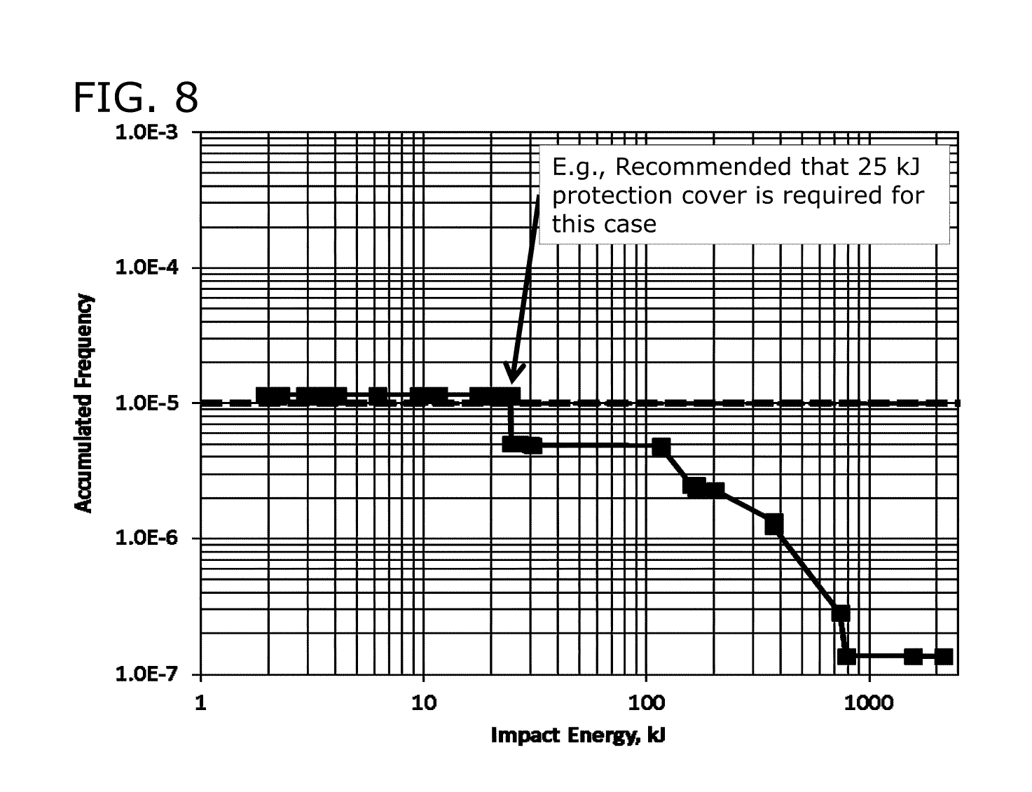

FIG. 8 graphically represents the accumulated leak or damage frequency per subsea element calculated with the method according to the invention from matrix-type data. The intersection of bold line and dotted line on the accumulated frequency of 1.0E-5 at 25 kJ may be interpreted as a recommendation of a required protection cover of minimum 25 kJ for this case.

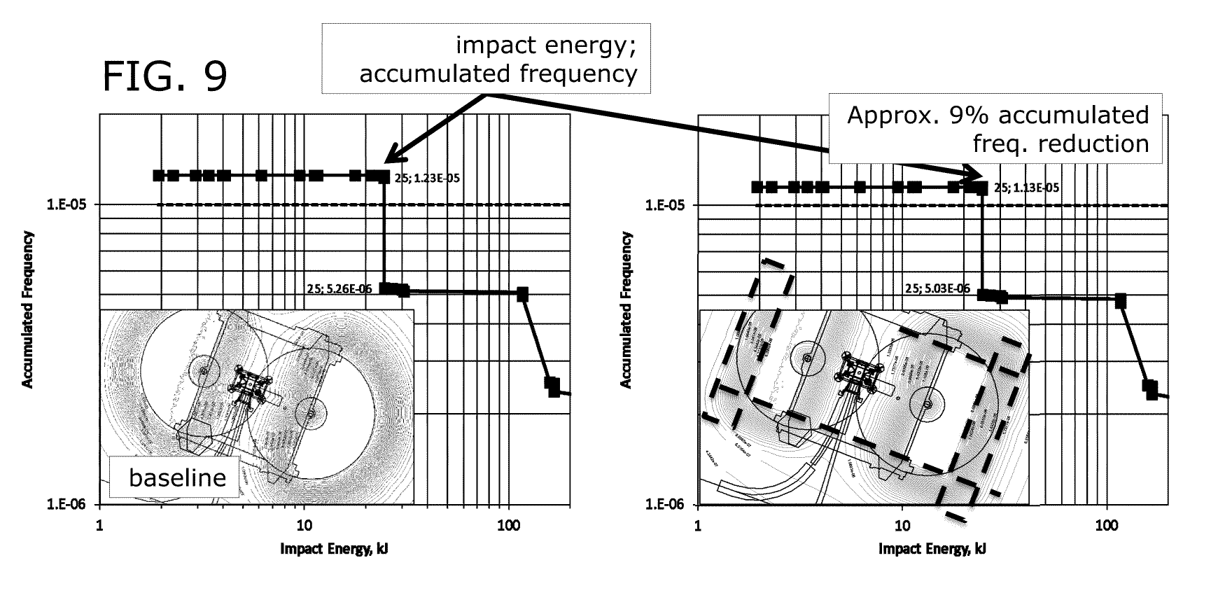

FIG. 9 graphically represents the accumulated leak or damage frequency vs. impact energy calculated from matrix-type data. An optimization analysis of introducing a supply vessel (right graph) compared to the baseline (left graph). Introduction of the supply vessel results in approximately 9% reduction in accumulated frequency. A supply vessel parallel with the platform (right graph) is positioned at each crane.

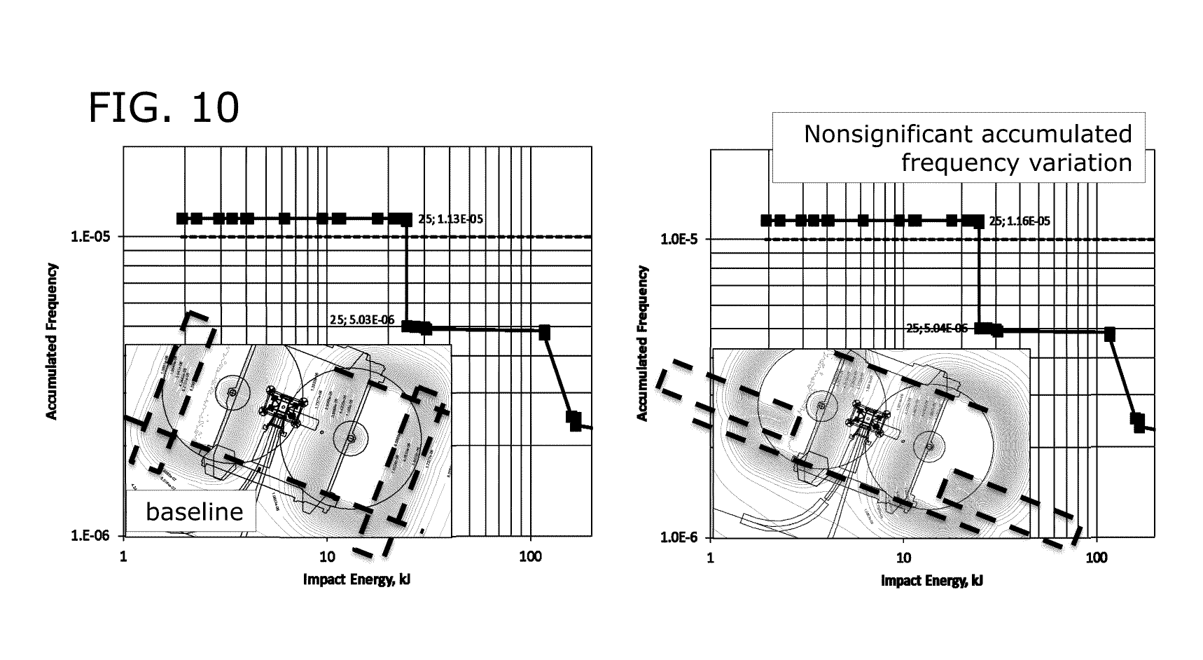

FIG. 10 graphically represents the accumulated leak or damage frequency vs. impact energy calculated from matrix-type data. An optimization analysis is shown of modifying the position of the supply vessel parallel with the platform (left, baseline) as compared to the orthogonal position (right) of the supply vessel. A non-significant accumulated frequency variation is observed. A supply vessel is positioned at each crane.

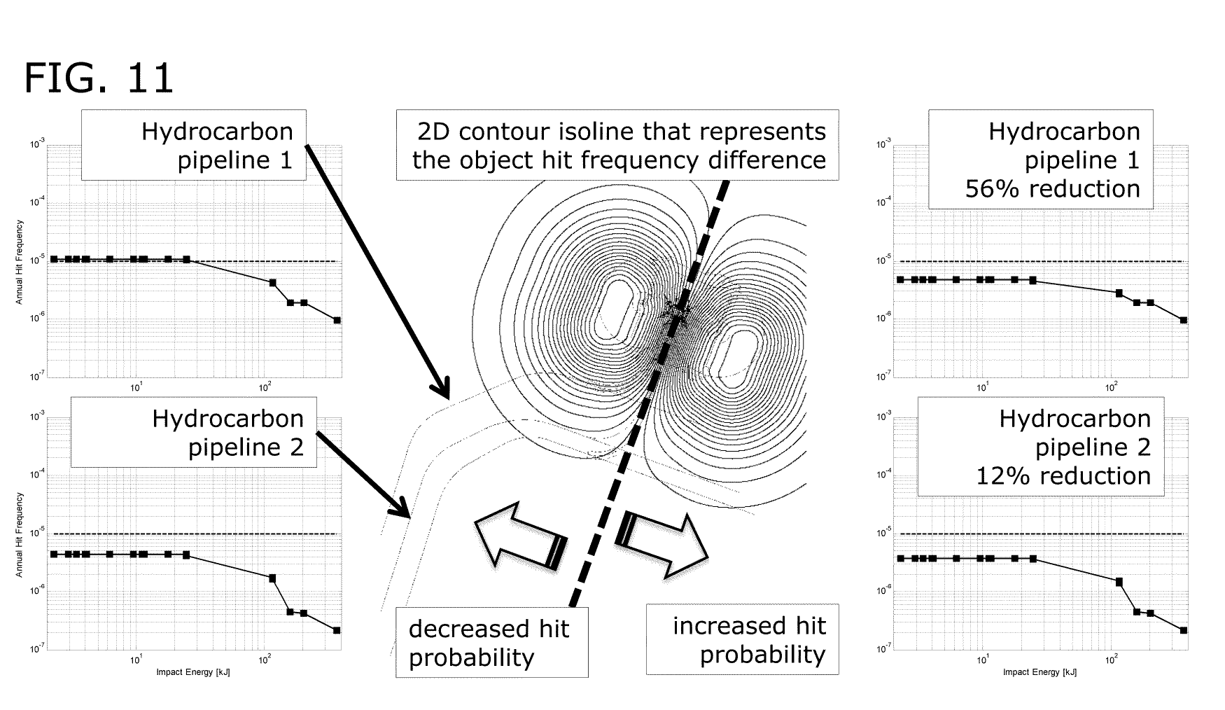

FIG. 11 shows optimization analysis of lifts when parts of the lifts are lifted with port crane compared to the initial planned starboard crane. Accumulated hit frequency vs. impact energy is calculated in each optimization case for each of a hydrocarbon pipeline 1 and a hydrocarbon pipeline 2 when lifts are performed. The the difference in hit frequency is represented as contour isolines for each of these situations. A decrease of the accumulated leak frequency per subsea element is estimated when part of the lifts of the object loads are lifted with a port crane compared to the initial planned starboard crane of the platform. 2D contour isoline representations of the difference in hit frequency are shown. A 56% reduction in annual hit frequency is estimated for hydrocarbon pipeline 1, and a 12% reduction in annual hit frequency is estimated for hydrocarbon pipeline 2.

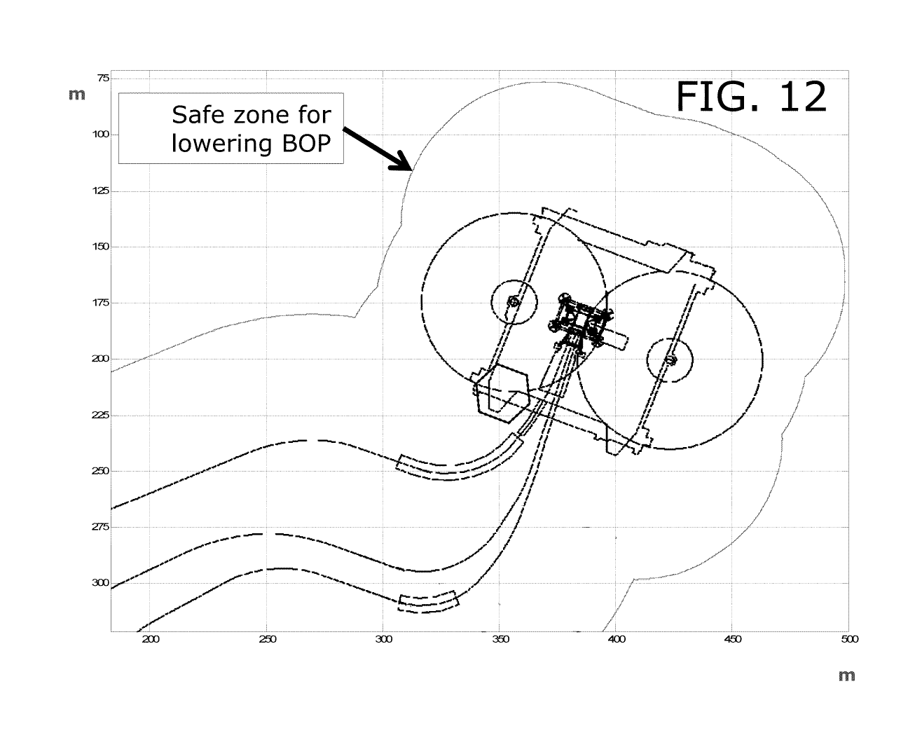

FIG. 12 shows a safe zone for lowering a BOP. The safe zone is marked as a contour line. The contours of the hydrocarbon pipelines and the subsea assets, the “sea level area” and the handling areas of the cranes are also shown. The values are calculated from matrix-type data. The safety zone for lifting of BOP is established based on the defined acceptable hit probability of 10⁻⁴ for both drilling and completion operations and based on frequency for dropped objects into the sea (source: DNV-RP-F107), where handling of BOP/load >100 tones with the lifting system in the drilling derrick is 1.5*10⁻³.

Using combined numeric inputs and graphical interface for extracting the position of the crane, the described method (and the designed tool) easily employs optimization of crane operating restrictions; sensitivity analysis on vessel positions; optimization of lifting procedures and landing areas on the platform/rig/vessel; estimation of the adequacy of existing/designed protection cover capacity and validate cover capacity calculations; visualizations and decision support for routing of subsea pipelines during design; and optimization of BOP and other heavy objects' safe distance lowering.

Contrasting existing methods, this invention proposes assessing the risk from thousands of random drops from the possible drop area on above “sea-level area”. With this, embodiments of this invention use the entire area of possible drops as opposed to estimates made without using adequate or complete information of possible drop area.

A risk management tool for estimating accidental dropped object loads on subsea pipelines and other subsea assets is also provided. The tool performs the method as described above. The tool comprises input means and outputs means, as well as a number of modules performing the calculations and estimations to generate and visualize the risk. The tool comprises a computer system with software and hardware modules. The tool also provides flexibility on the input data formats. Drawings of the subsea layout and drop area layout (platform, cranes, lift area, restrictions etc.) may be provided from e.g. AutoCAD files, from Adobe PDF documents, or from scanned documents. The visualizations may be presented graphically on a display device. Advanced visualization capabilities are provided enabling interpretation and clear communication of results to stakeholders. The tool may thus also be used as a decision support system and method.

The drop area may be optimized by optimizations of crane restrictions or sensitivity analysis for supply vessel position. Optimizations of lifts may be decided based on optimizations (in terms of risk of dropped objects) for landing areas and storage on the platform as well as design for water integrity for lifts and tubes. Analysis of the protection cover capacity adequacy and cover capacity may be performed and optimizations provided on the basis of these analysis. Subsea layout optimization may be achieved through visualizations and decision support for routing of subsea assets to minimize the risk of dropped objects. A safe zone of BOP lowering may be optimized.

The invention also provides a business consultancy method, or business management system, providing mitigation measures or risk reduction as explained above.

Having described preferred embodiments of the invention it will be apparent to those skilled in the art that other embodiments incorporating the concepts may be used. These and other examples of the invention illustrated above are intended by way of example only and the actual scope of the invention is to be determined from the following claims.

1. A method of estimating risk of at least one accidentally dropped object load from at least one crane on a platform or vessel, comprising:
providing or generating a schematic representation of a sea level area comprising at least a layout of the platform or vessel and a layout of a maximum and minimum crane handling radius of the at least one crane;
identifying a drop area for accidental drops of the at least one accidentally dropped object load from the crane based on image processing of the schematic representation of the sea level area;
estimating probability density of risk of accidentally dropped object loads based on a multitude of drop points within the drop area for the at least one accidentally dropped object load or at least one object category; and
representing the sea level area, the subsea area, and estimating probability of risk of accidentally dropped object loads using data representations in the form of at least one of matrix-type data, raster graphic image, or dot matrix data for location, estimated risk values and other statistics.

2. Method according to claim 1, further comprising
representing a probability density of risk of the at least one accidentally dropped object load as contour isolines, isarithms or isopleths on the schematic representation of the sea level area.

3. Method according to claim 1, further comprising
estimating a hit probability function based on two-dimensional normal distribution for at least one accidentally dropped object load.

4. Method according to claim 1, further comprising
providing a schematic representation of a layout of a subsea area comprising the subsea pipelines and other subsea assets, and extracting from said schematic representation of the layout of the subsea area at least segments and sub-segments of the subsea pipelines and the subsea assets generating a mask of said subsea pipelines and the subsea assets.

5. Method according to claim 4, further comprising
extracting the area where an accidental drop may affect respective segments and sub-segments of pipelines and other subsea assets.

6. Method according to claim 4, further comprising
estimating risk of dropped objects or a hit probability for each segment of subsea asset, pipeline, and other subsea assets.

7. Method according to claim 6, further comprising
using interpolation to improve accuracy for at least one estimate of risk of dropped objects or a hit probability.

8. Method according to claim 4, further comprising:
representing a probability density of risk of the at least one accidentally dropped object load as contour isolines, isarithms or isopleths on the schematic representation of the sea level area; and
representing the segments and sub-segments of pipelines and other subsea assets, or area where an accidental drop hit may affect respective segments and sub-segments of pipelines as contours together with the contour isolines, isarithms or isopleths of the probability density of risk.

9. Method according to claim 1, further comprising
estimating a probability density of risks of the at least one accidentally dropped object load for at least a part of a safe zone of the subsea area based on the multitude of dropped objects.

10. Method according to claim 1, further comprising:
representing a participation of a lift or combination of lifts by the at least one crane as a risk probability density for at least a part of a safe-zone of the subsea area by contour isolines, isarithms, or isopleths providing quantitative iso-values of risk caused by the at least one accidental dropped object load to the subsea pipeline or subsea assets.

11. Method according to claim 1, further comprising:
representing a participation of a lift category or combination of lift categories of lifts of an object load by the at least one crane by contour isolines, isarithms, or isopleths providing quantitative iso-values of risk caused by the at least one accidental dropped object load to the subsea pipeline or subsea assets.

12. Method according to claim 1, further comprising:
defining limitations of the supply vessel position or optimizations of such position to reduce the risk of accidental dropped objects on subsea assets.

13. Method according to claim 1, further comprising:
optimizing or defining limitations of a crane handling area based on living area or restricted zones on the platform.

14. Method according to claim 1, further comprising:
optimizing or defining limitations based on a crane mobility limitations as an angle.

15. Method according to claim 1, further comprising:
calculating a hit probability of each sub-section of the subsea pipeline or subsea asset from matrix-type data, raster graphic image, or dot matrix data structure.

16. Method according to claim 1, further comprising:
calculating a hit probability of the subsea pipeline or subsea asset from matrix-type data, raster graphic image, or dot matrix data structure.

17. Method according to claim 1, further comprising:
calculating at least one of a hit frequency vs. impact energy from values extracted from matrix-type data, raster graphic image, or dot matrix data structure.

18. Method according to claim 1, further comprising:
calculating at least one of a damage classification or accumulated frequency vs. impact energy from values extracted from matrix-type data, raster graphic image, or dot matrix data structure.

19. Method according to claim 1, further comprising:
calculating a safe distance from the subsea pipelines and subsea assets for lowering a BOP or estimating risk of dropped objects while performing heavy lifts of at least an object load by the at least one crane.

20. A risk management tool for estimating accidental dropped object loads on subsea pipelines and other subsea assets, using the method according to claim 1.

21. A decision support method for estimating accidental dropped object loads on subsea pipelines and other subsea assets, using the method according to claim 1.

22. A risk management planning; optimizing lifts; or other marine operations based on embodiment of the present invention, using the method according to claim 1.

23. A business consultancy method, or business management system, providing mitigation measures or risk reduction consultancy using the method according to claim 1.
